(19) United States
(12) Patent Application Publication
(10) Pub. No.: US 2003/0035131 A1
(43) Pub. Date: Feb. 20, 2003

(54) Security documents with visible and invisible markings

(76) Inventors: Shlomo Dukler, Tel Aviv (IL); Avi Landman, Kiryat Halm (IL)

Correspondence Address: ALTERA LAW GROUP, LLC, 6500 CITY WEST PARKWAY, SUITE 100, MINNEAPOLIS, MN, 55344-7704, US

(21) Appl. No.: 10/027,214

(22) Filed: Dec. 21, 2001

Related U.S. Application Data
(63) Continuation of application No. PCT/IL00/00004, filed on Jan. 3, 2000.

(30) Foreign Application Priority Data
Jun. 21, 1999 (IL) 130584

(51) Int. Cl. B41F 1/00; G06F 15/00

(52) U.S. Cl. 358/1.14

(57) ABSTRACT

A difficult-to-counterfeit document comprising, together with data printed in visible form, invisible indicia that are personalized in nature, and which cannot be seen without the cooperation of an external factor. The invisible indicia are printed with a luminescent ink or toner, and becomes visible by the application of irradiaton, such as UV light. The luminescent ink or toner may comprise fluorescent materials. The same type of document may bear different invisible indicia for different bearers or documents, and may be printed by conventional digital printing methods.

### FIELD OF THE INVENTION

The invention relates to the personalisation of documents for the purpose of authentication, and to means for revealing their presence in documents which have been personalized.

### BACKGROUND OF THE INVENTION

The problem of marking various objects with identifying marks or codes, which are invisible in normal light, has been addressed several times in the prior art. For instance, U.S. Pat. No. 3,507,655 describes and claims a process for producing marking invisible in natural light but visible in ultraviolet (hereinafter UV) light on a plastic substrate exhibiting fluorescent properties, but wherein a source of intense optical radiation is impinged on the substrate through a stencil bearing the desired marking pattern, the radiation causing a change in the fluorescence in the substrate in the irradiated area, so that the marking is invisible in ordinary light, but visible under UV illumination.

U.S. Pat. Nos. 5,225,900 and 5,301,044 disclose incorporating patterns into marking materials used to create images. Reproduction systems detect the patterns and use the resulting information to control reproduction.

U.S. Pat. No. 4,366,217 discloses making a motion picture film which has a plurality of digitally coded sound tracks which are colored and transparent to visible light and which fluoresce when exposed to UV light.

None of the prior art systems, however, are successfully applicable to normal printing or copying systems and apparatus and they all involve operations additional to printing or copying, causing increased manufacturing complication and costs.

Additionally, and this is a primary concern of this invention, no personalized documents, including indicia invisible by simple inspection, have ever been provided by the prior art.

It is therefore a purpose of this invention to produce secure, personalized documents, bearing invisible indicia, particularly by means of standard copying or printing equipment. While reference will be made hereinafter only to the production of documents, for brevity's sake, it should be understood that the invention is applicable to any substrate on which any graphic matter, including e.g. letters, numbers, signs and/or pictures of any kind, can be produced by printing or copying systems and apparatus.

It is another purpose of this invention to produce, by standard copying or printing methods, labeled documents having personalized identifying markings that are not visible under normal light but become visible under excitation causing fluorescence, in particular irradiation with UV light or light comprising UV wavelengths.

It is a further purpose of this invention to produce documents which cannot be reproduced by photographic, xerographic or any other copying methods, since any such reproduction is easily recognizable from the original document, and the authenticity of which can therefore be verified.

It is a still further purpose of this invention to provide toner compositions, more specifically solid toner compositions, which, when used in standard printing or copying systems and apparatus, will produce labeled documents that are identifiable and any copies of which are distinguishable from the original.

It is a still further purpose of this invention to provide a process for making such toner compositions.

It is yet another purpose of this invention to provide liquid ink compositions, which, when used in standard printing or copying systems and apparatus, will produce labeled documents that are identifiable and any copies of which are distinguishable from the original.

It is a still further purpose of this invention to provide means for recognizing the labeled documents and distinguishing them from copies thereof.

Other purposes and advantages of this invention will appear as the description proceeds.

### SUMMARY OF THE INVENTION

The present invention relates to a method for printing on documents a visible or invisible image that can be used to verify, by a naked eye, the authenticity of the document. The image comprises invisible indicia that are personalized in nature, and which cannot be seen without the cooperation of an external factor. In this context, the term “invisible” is used to indicate indicia which cannot be seen with the naked eye without the cooperation of an external factor, but which can be easily seen with the naked eye by the cooperation of an eternal factor.

In a preferred embodiment of the invention the invisible indicia comprise luminescent, particularly fluorescent, ink, and the external factor is a UV light irradiation. By irradiating the document with UV light, luminescence emission is obtained from the invisible indicia, thus rendering the indicia visible.

In the context of the present invention, the terms “ink” and “toner” are used interchangeably, for the sake of brevity, to indicate any kind of ink, including liquid or semi solid ink, e.g., for ink-Jet or bubble-jet printers, and toners used in laser printing apparatus.

According to the invention the indicia is personalized, so that the same document bears different invisible indicia for different bearers or documents, and is printed by conventional digital printing methods.

Illustrative and non-limitative examples of invisible indicia that can be printed by the luminescent toner are, e.g., image of the bearer (or any other), signature, one- or two-dimensional barcode label, text (of any kind or size) or any other marks that need to be printed in order to differentiate one document from the others.

The invention also encompasses all kind of personalized documents prepared according to the method of the invention, particularly laminated documents.

According to the invention, a luminescent toner or ink is produced, for use in digital printing process in a way that the luminescent toner or ink will produce a luminescent personalized image on documents such as ID, passports, driver license, and any other document requiring protection against counterfeiting, such as, e.g., banknotes, bonds, stocks, etc.

The presence of labeling dyes which have no substantial chromatic effect and/or distortion on the toner colors does not substantially interfere with the production of multicolor graphic matter, although, in principle, minor chromatic effects and/or distortions can be compensated by appropriate programming of the printing or copying apparatus. It will be understood, however, that this requirement may not be relevant if the graphic matter is in black. Further, the labeling dyes must not interfere substantially with the printing or copying process, in particular with deposition of the toner composition on the print receiver, its transfer to the print substrates and its setting. This requirement is generally satisfied by fluorescent compounds. It should be understood that, while in general the labeling dyes will be fluorescent compounds, in some cases they may be other substances having different properties that are not transferred to copies made with conventional toners. Thus, magnetic powders could be used, particularly if the graphic matter is black. All those variants are broadly comprised in the invention, as long as they satisfy the requirement that the materials used are invisible to the naked eye, and can be seen, directly or indirectly, by using an external factor.

In any case, the labeling dyes, used in the production of the original labeled document, will not be present in any reproduction of the document, such as e.g. photographic or xerographic, carried out with conventional toner compositions, or at least, toner compositions different from those used in the original document, and their presence, which is detectable in the labeled, original document, will not be detected in any such reproduction thereof.

Examples of suitable labeling dyes for carrying out the invention are fluorescent compounds chosen from polycyclic compounds in general, and coumarin derivatives in particular. Particularly preferred are:

Dansylchloride

4′,6-diamidino-2-phenylindole

5-(4,6-dichlorotriazin-2-yl) aminofluorescein

4,4′-diisothiocyanopropylin-2,2′-disulfonic acid

teosin isothianate

erythrosin B

fluorescamine

fluorescin and its derivatives

4-methylumbelliprone

o-thaldialdehyde

rhodamine B and its derivatives

rhodamine 6-G and Rhodamine 6G Perchlorate

2,5 dibiphenylyloxazole

p-bis[2(5-phenyloxazolyl)benzene]

9,10-bis(phenyl-ethyl)antracene

9(p-vinytphenl)-I0-phenyl-antracene

Eosin B and Eosin Y

Y₂0₃:Eu Lantinide Chelate

Rubrene

N-(4-anilino-l-naphthyl)maleimide

The luminescent material is irradiated by UV light in the range between 250-366 nm and fluoresces in the visible spectrum between 400-700 nm. Some of the compound materials will give an emission NIR and a few of the compounds will be good for thermo-chromic materials.

Other suitable luminescent compounds and the preparation of solid or liquid ink comprising them, are known in the art and are described, e.g., in U.S. Pat. No. 6,554,480 and U.S. Pat. No. 4,865,937, the description of which is fully incorporated herein by reference.

It can be possible to produce a toner with multiple combinations of markers, which produce a set of more than 2 emission wavelengths that can then be visually detected.

It is possible to manufacture each document with several different toners or inks of different colors, which each contain a different marking material. The detection can be performed visually.

The document can be manufactured by, but not limited to, digital printing methods. laser printers, fax machines, ink jet printers or copying machines.

The printing/authentication process, according to a preferred embodiment of the invention, is carried out using conventional printing techniques, but employing the toner or ink according to the invention. This process can be generally described as follows:

1. A personalized record is created, which is suitable for digital printing.

2. A computer or the like equipment in which said record is created and/or stored is connected to a digital-printing device. The digital-printing device contains printing consumables that consist of luminescent toners or inks.

3. An application program that retrieves the personalized data record from the database is then accessed and the personalized data record is printed on the digital printer, using both regular ink/toner, and one or more marked ink(s) or toner(s).

4. Additional, optional steps, may comprise release transfer techniques and or lamination of the document may be required to complete the secured document.

5. The authenticity of the document is determined visually, with the aid of irradiation of the document by short and/or long wavelengths. The emission due to the excitation from the source lights is visible to the eye.

### BRIEF DESCRIPTION OF THE DRAWINGS

In the drawings:

FIG. 1 schematically illustrates a personalized difficult-to-counterfeit document, bearing invisible indicia, according to a preferred embodiment of the invention; and

FIG. 2 schematically illustrates a personalized difficult-to-counterfeit document, bearing invisible indicia, according to another preferred embodiment of the invention.

### DETAILED DESCRIPTION OF PREFERRED EMBODIMENTS

The labeling composition, comprising the labeling compound according to this invention, is prepared as described hereinbefore and as will be exemplified hereinafter.

Once a printed document has been prepared by means of the labeled toner according to the invention, and when the printed document is subjected to lamination particularly with overlying transparent plastic layers, which have the purpose of protecting documents and preventing additions or counterfeiting, the compound dissolves in the adhesive which is released in the lamination process. Solution of the labeling compound into the glue causes a shift of its fluorescence from the fluorescence of the crystallites to the fluorescence of the material in the solution, to shorter wavelengths. The fluorescence intensity is heightened, with respect to that in the solid state.

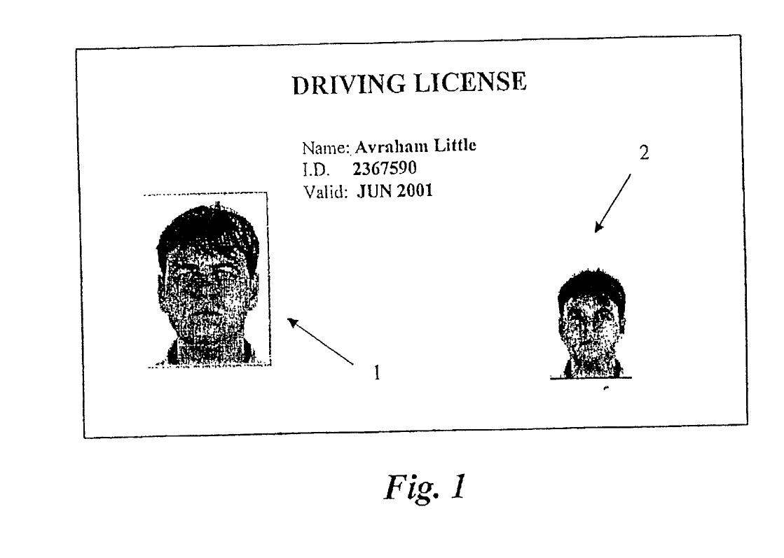

In FIG. 1 a simplified Driver License is shown, which comprises the bearer's photograph, as is customary in most driving licenses. The photograph indicated by numeral 1 is the regular driver's photograph, that has been digitized and printed with color toner, e.g., on a color laser printer. The photograph indicated by numeral 2, on the other hand, is a reduced replica of photograph 1, printed with fluorescent toner. Photograph 2 may be printed in one or more colors. Photograph 2 is invisible to the naked eye, unless UV irradiation is applied to it, which results in the fluorescence of the indicia that thus becomes visible.

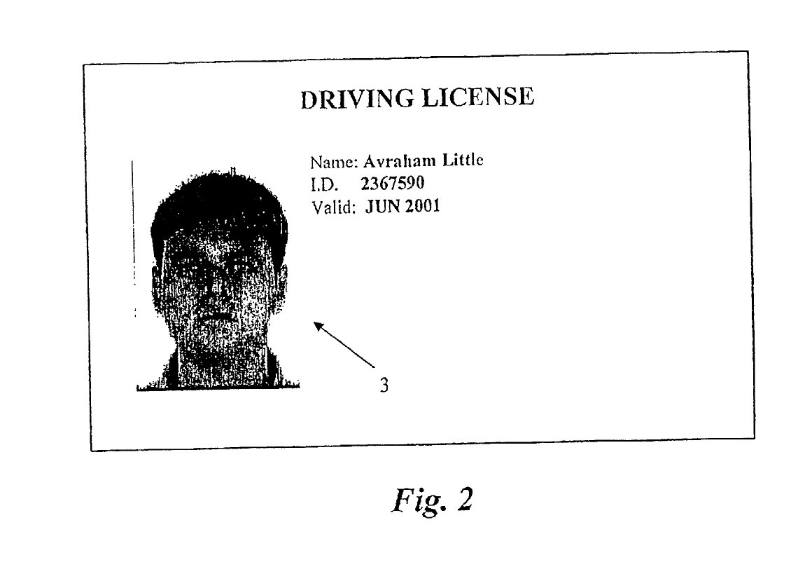

FIG. 2 illustrates a personalized authenticated driver license, according to another preferred embodiment of the invention. In the document of FIG. 2 the luminescent printing has been superimposed with the regular photograph. As long as no UV light is applied, only the visible photograph is seen, but when UV light is applied, as shown in FIG. 2, the invisible photograph becomes now visible, and appears, in the particular embodiment of the example, as a halo superimposed with the original photograph.

As will be apparent to the skilled person, the personalisation of the document requires a precision obtainable only by the precise printing of the invisible indicia according to personalized data provided in digital form during the printing process. Thus, documents produced according to the invention are extremely difficult to imitate.

The invisible indicia can of course be of many different types, and are by no means limited to photographs. Signature of the bearer and any other personalized data or manner of displaying data, are all suitable in order to carry out the invention.

The toner colors and labeling dyes, which make up the toner compositions in particulate, such as granular or powdery form, may be associated into toner composition particles in various ways. For example, two solvents may be used, to be indicated hereinafter as solvent (a) and solvent (b), which must be miscible. Solvent (a) muse be a solvent for the labeling dyes and may be, e.g., an alcohol such as ethanol, methanol or propanol. Solvent (b) must not dissolve the labeling dyes and must not dissolve or destroy the toner particles: therefore, while it is called '“solvent (b)” herein, it is a non-solvent both for the labeling dyes and for the toner particles. Water, for example, is a convenient such solvent. The two solvents are mixed and the labeling dye is dissolved in the mixture (a)+(b), in such an amount that the resulting solution will be approximately saturated with the dye, viz. close to the dye precipitation limit. The amount of dye that is so dissolved will depend on the ratio (a)/(b), which therefore should be high enough to permit to obtain, in each specific case, the desired concentration of dye,

The toner is preferably added into the said solvent mixture which already includes the dye. If it were added to the solvent (a), it would be damaged, since its components are dissolved in pure or highly concentrated solvent (a). The ratio (a)/(b) must be such as not to damage the toner, but cause the toner particles to become sticky. In this condition the dye crystallites that form by precipitation are bound into the toner particles and remain bonded thereto after a successive drying process, It is also possible to prepare a solution of dye in solvent (a) on the one hand and an aqueous suspension of the toner in solvent b), on the other hand, and mix the two.. However, in this case, care must be taken that the concentration of the solution of dye in solvent (a) be such that, when it is mixed with the aqueous suspension of the toner in solvent (b), the resulting solution in the solvent mixture be approximately saturated with the dye.

Since the ratio of the two solvents is such that their mixture is approximately saturated with the dye, viz. close to the dye precipitation limit, some dye precipitation will occur immediately. Slow evaporation of solvent (a) is then carried out, at such a rate that the system be kept close to its precipitation limit by such slow evaporation. Under these conditions, the already formed dye crystallites will grow, but no new precipitation centers of the labeling dye will be created. As a result, the toner particles are bounded to rather large dye crystallites that can emit fluorescent radiation. After complete precipitation of the dye, the resulting toner composition is filtered and dried.

The fluorescent compound or compounds used should, as has been said, preferably be colorless and, therefore they may be considered colorless toners. They should also be such as not substantially to alter the colors of the toner colors, although some alteration is tolerable and can be taken into account. Likewise, it is desirable that the colorless toner should not affect substantially the electrostatic and thermal properties of the toner colors, and therefore nor interfere with their deposition on the print receiver or their setting by fusing in such processes as laser printing and the like.

All the above is of course applicable, mutatis mutandis, to the use of labeled liquid or semi-solid inks, e.g., for inkjet or bubble-jet printers. The production of liquid inks, however, is much simpler than that of solid toners, and is therefore not described herein in detail, for the sake of brevity, since the addition of luminescent markers to liquid ink compositions is within the skill of the routineer.

### EXAMPLE 1

30 mg of labeling dye, which in this example is 7-diethylamino-4methylcoumarin, were dissolved in 1 ml of ethyl alcohol (analytical grade). 1 g of the coloring matter of the toner was suspended in 40 ml of water. The dye solution was added slowly to the suspension, while string vigorously. Mild heating was used to reach the precipitation point. The process took two hours. The maximum temperature reached in the heating is 40° C. After the precipitation is completed, the resulting toner composition is filtered and dried.

### EXAMPLE 2

Solutions of the luminescent material were prepared in a concentration of 0.001% to 10% in an alcoholic solution, such as, EtOH, Iso-propyl alcohol, n-buthyl-alcohol or ethyl acetate. The solution was added to distilled water. The toner or ink was dispersed in an aqueous solution, H₂O—EtOH 1:1 or H₂O-iso propyl alcohol. The solution of the luminescent pigment of concentration 0.001% to 10% was added to the aqueous-alcoholic solution and was mixed vigorously for up to two-hours using a laboratory mixer from 200-800 RPM. After filtering the toner from the aqueous-alcoholic solution, the powder was dried to room temperature and was ready for use.

### EXAMPLE 3

In the case of organic ink, the luminescent pigment was dissolved in an organic solvent, such as, ethy-alcohhoI, iso-propyl alcohol or ethy-acetate but not limited to these solvents. This organic solution was poured into the organic ink and was mixed thoroughly for up to two hours using a laboratory mixer from 200-800 rpm. It was then ready for use.

By this method there were prepared cyan, yellow, magenta, and black toner and ink color, but the method is not limited to these colors and can be implemented on any color type including pigmentless or colorless toners and inks.

While embodiments of the invention have been described by way of illustration, it will be apparent that the invention may be carried out by persons skilled in the art with many modifications, variations and adaptations, without departing from its spirit or exceeding the scope of the claims.

1. A difficult-to-counterfeit document comprising, together with data printed in visible form, invisible indicia that are personalized in nature, and which cannot be seen without the cooperation of an external factor.

2. A document according to claim 1, wherein the invisible indicia are printed with a luminescent ink or toner.

3. A document according to claim 2, wherein the invisible indicia becomes visible by the application of irradiation.

4. A document according to claim 2, wherein the luminescent ink or toner comprises fluorescent materials.

5. A document according to claim 3 or 4, wherein the irradiation is UV light.

6. A document according to any one of claims 1 to 5, wherein the same type of document bears different invisible indicia for different bearers or documents, and is printed by conventional digital printing methods.

7. A document according to claim 6, which has been printed by a laser printer.

8. A document according to claim 6, which has been printed by a liquid ink printer.

9. A document according to claim 8, which has been printed by a bubble-jet or ink-jet printer.

10. A document according to any one of claims 1 to 9, wherein the invisible indicia that can be printed by the luminescent toner or ink comprise an image of the bearer, a signature, one- or two-dimensional barcode label, text matter or any other mark that can be printed in order to differentiate one document from the others.

11. A document according to any one of claims 1 to 10, which is selected from among an ID document, a passport, a driving license, banknotes, stocks, bonds, security papers, and any other document requiring protection against counterfeiting.

12. A method for generating a difficult-to-counterfeit document, comprising printing on the document, by conventional digital printing processes, together with data printed in visible form, invisible indicia that are personalized in nature, and which cannot be seen without the cooperation of an external factor.

13. A method according to claim 12, wherein the invisible indicia are printed with a luminescent ink or toner.

14. A method according to claim 13, wherein the invisible indicia becomes visible by the application of irradiation.

15. A method according to claim 13, wherein the luminescent ink or toner comprises fluorescent materials.

16. A method according to claim 14 or 15, wherein the irradiation is UV light.

17. A method according to any one of claims 12 to 16, wherein documents of the same type are printed with different invisible indicia for different bearers or documents.

18. A method according to claim 17, wherein the document is printed by a laser printer.

19. A method according to claim 17, wherein the document is printed by a liquid ink printer.

20. A method according to claim 19, wherein the document is printed by a bubble-jet or ink-jet printer.

21. A method according to any one of claims 12 to 20, wherein the invisible indicia that can be printed by the luminescent toner or ink comprise an image of the bearer, a signature, one- or two-dimensional barcode label, text matter or any other mark that can be printed in order to differentiate one document from the others.

22. A method according to any one of claims 1 to 21, wherein the document to be printed is selected from among an ID document, a passport, a driving license, banknotes, stocks, bonds, security papers, and any other document requiring protection against counterfeiting.

23. Laminates, comprising documents according to any one of claims 1 to 11.

24. A difficult-to-counterfeit document, substantially as described and illustrated.
